(19) United States
(12) Patent Application Publication
(10) Pub. No.: US 2004/0021565 A1
(43) Pub. Date: Feb. 5, 2004

(54) Danger alert device with communication interface and danger alert system

(76) Inventors: Martin Rechsteiner, Mannedorf (CH); Marc Sennhauser, Jona (CH)

Correspondence Address: BAKER & BOTTS, 30 ROCKEFELLER PLAZA, NEW YORK, NY, 10112

(21) Appl. No.: 10/456,693

(22) Filed: Jun. 5, 2003

(30) Foreign Application Priority Data
Jun. 10, 2002 (EP) 02012786.6

(51) Int. Cl. G08B 1/08

(52) U.S. Cl. 340/539.1

(57) ABSTRACT

A danger alert device (M) includes a sensor for a danger parameter, evaluation electronics for evaluating sensor signals, a memory for storing alarm data, and a communication interface (K) for the wireless communication of the danger alert device (M) with a remote operator control module (H). The communication interface (K) is designed for communication in the radio-frequency range, preferably in accordance with the Bluetooth standard, or in the infrared range, preferably in accordance with the IrDA standard, and comprises corresponding transmission and receiving means. The operator control module (H) is formed by a remote control or a computer of a PC, laptop or hand-held type and has an analog communication interface (K′).

The present invention relates to a danger alert device with a sensor for detecting a danger parameter, evaluation electronics for evaluating signals from the sensor, a memory for storing alarm data, and a communication interface by which the danger alert device communicates with a remote operator control module.

### BACKGROUND OF THE INVENTION

Modem, high-end danger alert devices such as, for example, movement alert devices, are capable of receiving multiple parameter input and storing data and status information, acquired during operation, which are then available to be read out of the alert device by an authorized person. Such data may be, for example, operational information, alarm data of all types such as, for example, the type and time of an alarm, near-alarms, etc. In the case of movement alert devices, cameras and location images may also be involved. Since movement alert devices are generally mounted at a height where they cannot be reached without the use of aids (e.g. a ladder), a wireless data transmission would be highly advantageous.

EP-A-0 872 817 describes a danger alert device which comprises a communication interface for transmitting data recorded by the alert device. The interface is preferably formed by the light source for displaying the alarm, the so-called alarm indicator, or by an additional infrared source. The communication interface can also comprise a receiver for data transmitted from an external source, preferably an infrared receiver. The infrared receiver is disposed within the housing of the alert device and, when the housing cover is closed, is inaccessible from the outside. A data transfer between the alert device and an external module necessitates the removal of the housing cover, and its replacement by a special data transmission cover.

In such a danger alert device, communication between the alert device and the external module is not operator-friendly. In particular, the transmission of data from the module to the alert device is complicated and requires direct manipulation on the alert device with the result that, in practice, a parameterization of the alert device or a software update are not possible. In addition, the data transmission distance is limited.

### SUMMARY OF THE INVENTION

The present invention provides a danger alert device having a communication interface designed so that it is possible for data to be transmitted in both directions between an alert device and an external module without difficulty. The data communication is operator-friendly and, in particular, it is possible to exchange data with an alert device mounted at ceiling height. According to the present invention, the communication interface is designed for wireless communication and comprises corresponding transmission and receiving means.

In a preferred embodiment the danger alert device has a communication interface designed for communication in a radio-frequency range (preferably in accordance with the Bluetooth standard), or in an infrared range (preferably in accordance with the IrDA standard). The communication interface is formed by a transceiver, or by a separate transmitter and receiver. The “Bluetooth” standard is a short-range radio standard which operates with carrier frequencies from the 2.4 GHz “industrial, scientific and medical” band (ISM band) and provides for wireless connection of terminals in a radio cell with a radius of up to 10 meters, and in special cases up to 100 meters. “Bluetooth” is a trademark of Bluetooth SIG, Inc. IrDA is the abbreviation for “Infrared Data Association”, an organization which has defined the “IRDA DATA” industry standard for wireless data transmission by means of infrared, the standard which is now used for data exchange in many PDAs, mobile telephones, laptops, clocks, printers, digital cameras, etc.

In a further preferred embodiment of the danger alert device according to the present invention, the sensor is designed to detect heat radiation and receives infrared radiation through a window in the housing of the alert device. In this embodiment the transceiver, or transmitter and receiver forming the communication interface is disposed behind the window.

In yet another preferred embodiment of the danger alert device according to the present invention, the alert device further comprises a sabotage detector, comprising an infrared transmitter and an infrared receiver. The infrared transmitter or the infrared receiver is formed by the IrDA transceiver, or IrDA transmitter and IrDA receiver, which forms the communication interface.

The present invention further relates to a danger alert system with at least one danger alert device, comprising a sensor for a danger parameter, evaluation electronics for evaluating the sensor signals, a memory for storing alarm data, and a communication interface with a portable operator control module for wireless communication with the at least one danger alert device.

In the danger alert system according to the present invention the operator control module may be formed by a remote control, or a computer or PC, laptop or hand-held type, and comprises an analog communication interface such as the danger alert device. The two communication interfaces are designed for communication in the radio-frequency or infrared range.

In a preferred embodiment of the danger alert system according to the present invention, the communication interfaces are each formed by a transceiver or a transmitter and receiver, and the communication between a danger alert module and an operator control module is effected in accordance with the IrDA or the Bluetooth standard.

In another preferred embodiment of the danger alert system according to the invention, the danger alert device can be set to a data transmission mode through the operator control module.

In other preferred embodiments, the danger alert device is automatically set to the data transmission mode when the operator control module is authenticated as an allowed partner, or the authentication is effected by means of a code or a cryptological procedure.

In still another preferred embodiment of the present system, in the data transmission mode, data stored in the danger alert device, particularly alarm-related data and/or location images, are transmitted to the operator control module.

Another preferred embodiment of the danger alert system according to the invention is where a parameterization and/or software update of the danger alert device is/are effected in the data transmission mode.

In a further preferred embodiment, upon exchange of safety-related data in the transmission mode, the danger alert device dispatches a sabotage message.

### BRIEF DESCRIPTION OF THE DRAWINGS

The present invention is described in greater detail with reference to exemplary embodiments and drawings, wherein:

FIG. 1 illustrates a schematic representation of a danger alert device according to the invention, and of an operator control module, in the form of a remote control;

FIG. 2 illustrates a longitudinal section through a known passive infrared alert device; and

FIG. 3 illustrates a view in the direction of the arrow III of FIG. 2.

### DETAILED DESCRIPTION OF THE INVENTION

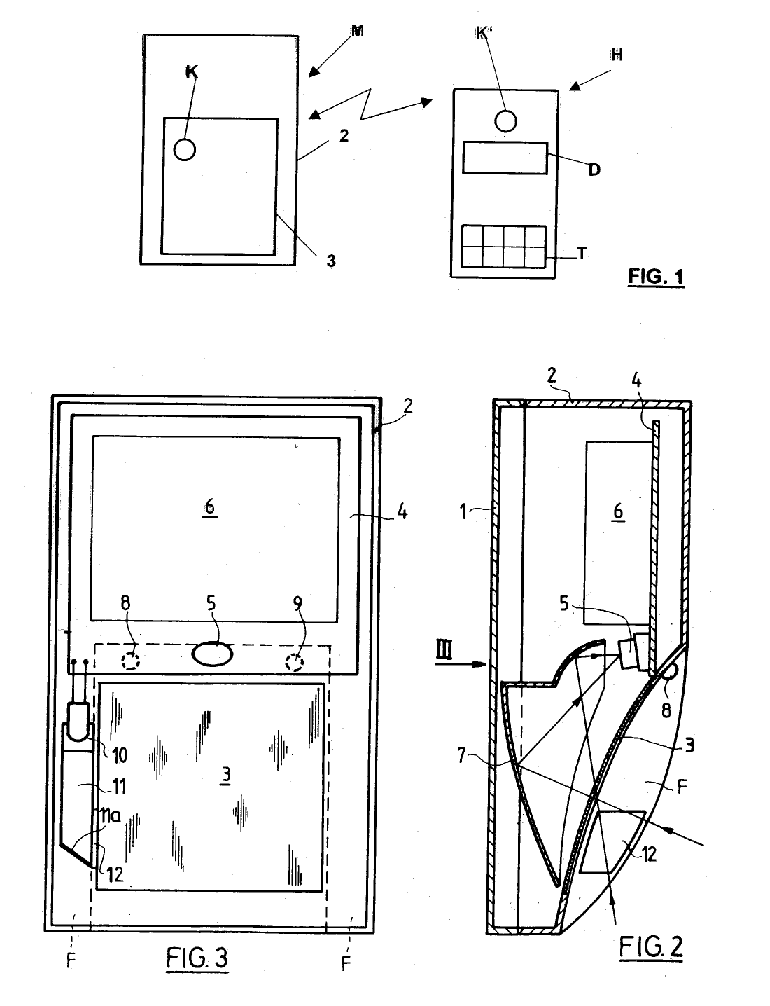

FIG. 1 shows, as a section from a danger alert system according to the invention, a danger alert device M, for example, a passive infrared alert device, and a portable operator control module H assigned to the latter. The operator control module H is used for exchanging data with the alert device M, which may be formed, for example, by a remote control, a PC, a laptop or a hand-held computer. In the case of the stated data exchange, data is transmitted both from the alert device M to the operator control module H (alarm-related data; location images, if the alert device M is equipped with a camera; operational data) and from the operator control module H to the alert device M (parameterization, software update of the alert device M). To enable this data exchange, both the alert device M and the operator control module H comprise a communication interface K and K′ respectively. The communication interfaces K, K′ are designed for the IrDA standard or the Bluetooth standard, and comprise an appropriate transceiver or a separate transmitter and receiver.

The term transceiver as used in the following refers in each case both to a combined transmitter/receiver and to a separate transmitter and receiver. IrDA relates to the industry standard “IrDA DATA” for wireless data transmission by means of infrared, developed by the Infrared Data Association. For further information relating to this standard, reference should be made to www.irda.org/standards. The “Bluetooth” standard is a short-range radio standard in the ISM band for wireless connection of terminals in a radio cell with a radius of up to 10 meters, and up to 100 meters in special cases. For further information relating to Bluetooth, reference should be made to www.bluetooth.com. Where reference is made only to communication interfaces K, K′ designed for the IrDA standard, this is not to be understood as limiting, but also to include the Bluetooth standard in each case.

For the purpose of data exchange for PDAs, mobile telephones, laptops, clocks, printers, digital cameras, toys and such, there are now commercially available IrDA transceiver (transmitter/receiver) and IrDA transmitter and IrDA receiver, which comply with the IrDA standard. The communication interfaces K, K′ are each formed by such a commercially available IrDA transceiver. The transmission distance is at least one meter, so that data communication can be achieved without difficulty, even in the case of a danger alert device mounted at a height of over three meters.

When an operator control module H is authenticated as authorized for communication with the alert device M, the alert device is set automatically to the data transmission mode. This authentication can be effected by means of a special code or a cryptological procedure (e.g. challenge-response sequence). This prevents the alert device M from being unintentionally or intentionally set to the data transmission mode by an unauthorized operator control module H. In this data transmission mode, software updates, in particular, are possible, whereby the software block which is to be replaced can be allocated a signature through appropriate cryptological procedures, and the signature can be verified in the alert device. Upon the exchange of safety-related data, the alert device M dispatches a sabotage message.

The alert device M, described in detail with reference to FIGS. 2 and 3, is preferably a passive infrared alert device with a housing cover 2 and an alert device window 3 provided in the latter, and through which infrared radiation received by the alert device from the space to be monitored passes into the interior of the alert device. The alert device M is provided with an anti-mask device having at least one infrared transmitter and one infrared receiver (see FIGS. 2 and 3) in each case, and the IrDA transceiver (communication interface) K forms one of the infrared transmitters or receivers. The operator control module H comprises, in addition to the communication interface K′, a display D and a keypad T comprising, for example, navigation buttons, a transmit key, and an on/off key.

FIG. 2 shows a longitudinal section through a known passive infrared alert device in the direction perpendicular to its back wall or base. FIG. 3 shows a view from behind, both the back wall of the alert device and the mirror which focuses the incident infrared radiation having been removed from the alert device. As shown, the passive infrared alert device has a two-part housing with a base 1 and a cover 2. Window 3 is provided in the cover 2 for the infrared radiation received by the alert device from the space to be monitored. A board 4 is disposed inside the alert device on which are disposed, among other items, an infrared sensor 5 and an evaluation circuit 6. A mirror 7 is also disposed inside the alert device for focussing the infrared radiation incident through the alert device window 3 on to the infrared sensor 5. The evaluation circuit comprises a memory (not shown) for storing operational and alarm data.

The alert device window 3, which may be made of polyethylene or polypropylene, is inserted in a beveled or concave portion of the cover 2, and delimited laterally by projections F of the cover 2. The mirror 7 is of such design that it absorbs radiation in the near-infrared and reflects body radiation. Reference is made to EP-A-0 303 913 for the form of the mirror, and to EP-A-0 707 294 for the mirror material, both of which are herein incorporated by reference. Window 3, mirror 7, infrared sensor 5, and evaluation circuit 6 serve to prevent a person from entering the monitored space. The alert device window 3 can be designed as a Fresnel lens and, instead of the mirror 7, can focus the infrared radiation on to the infrared sensor 5.

The passive infrared alert device depicted may be equipped with an anti-mask device for detecting occurrences or optical variations directly in front of the alert device or variations of the optical characteristics of the alert device window 3, particularly sabotage of the alert device. The purpose of such a sabotage is to manipulate the alert device in such a way that no infrared radiation can pass on to the infrared sensor, so that unauthorized persons are no longer detected and can move freely in the monitored space. Sabotage is mostly perpetrated when the alert device is not sharply focussed, when it is switched to a standby mode and persons present in the monitored space do not trigger an alarm.

The anti-mask device is constructed as follows: disposed on the front side of the alert device, just above the alert device window 3, are an optical transmitter 8, for example, an infrared LED with a 950 nm wavelength, and an optical receiver 9, for example, an infrared diode. The transmitter 8 is located on the outside of the housing cover 2 and the receiver 9 is located on its inside. The transmitter 8 radiates infrared radiation continuously from the alert device. In the normal operating state, this infrared radiation is radiated into the monitored space in front of the alert device. As soon as an object is brought or located in front of the alert device, however, a large portion of the radiation emitted by the transmitter 8 is reflected and passes through the alert device window 3 on to the receiver 9. The resultant increase in the received radiation is interpreted as an attempted masking.

In the interior of the alert device, in the area of one of the two wings F, is an additional optical transmitter 10, for example, an infrared LED, which transmits infrared radiation into a light shaft 11. The light shaft 11 is of an angled design and opens into an infrared-transmissive window 12 provided in the side wall of the respective projection F facing towards the alert device window 3. As shown, this projection F is the projection adjacent to the transmitter 8 and opposite the receiver 9. The infrared radiation emitted from the additional transmitter 10 passes through the light shaft 11, via a mirror 11a and the window 12, with a flat angle of incidence, on to the alert device window 3 and, under normal conditions, passes through the latter. The radiation emitted from the additional transmitter 10 is focussed through the window 12 on to the center of the alert device window 3, and passes through the latter on to the receiver 9.

If, however, the alert device window 3 has been masked, i.e., has been rendered non-transmissive of infrared, less radiation reaches the alert device window 3, or the radiation from the additional transmitter 10 incident on the entry window is reflected by the alert device window 3, and less radiation reaches the receiver 9, which is interpreted as an attempted masking. To prevent reflections of the radiation from the additional light source 10 emerging from the window 12, or of the radiation emitted from the transmitter 8 on to the side walls of the wings F, the latter are provided with an infrared-absorbent coating.

One of the infrared transmitters/receivers 8, 10 and 9 of the anti-mask device is formed by an IrDA transceiver and assumes the function of the communication interface K (FIG. 1). This is preferably the receiver 9 located behind window 3. The transmitter 10 cannot be used for this task since it is covered by the housing cover 2, but the transmitter 8 could obviously form the communication interface K.

A differently constructed anti-mask device is described in EP-A-1 061 489. In the case of the alert device described in this application there are provided, behind the alert device window, two infrared transmitters which are aligned towards the center of the alert device window and, disposed between them, an infrared receiver. The latter is disposed so that the radiation emitted from the infrared transmitters is reflected, in a proportion which is dependent on the optical characteristics of the alert device window, on to the infrared receiver. In the case of this alert device, therefore, the entire anti-mask device is disposed inside the alert device. In this case, the infrared receiver is preferably designed as a communication interface. An additional transmission and/or receiving diode, acting as a communication interface K, could also be provided and preferably disposed behind the alert device window.

What is claimed is:

1. A danger alert device comprising a sensor for sensing a danger parameter, evaluation electronics for evaluating signals from the sensor, a memory for storing alarm data, and a communication interface by which the device communicates with a remote operator control module, wherein the communication interface is designed for wireless communication and comprises transmission and receiving means.

2. The device according to claim 1, wherein the communication interface is designed for communication in the radio-frequency range, or in the infrared range, and is formed by a transceiver or by a separate transmitter and receiver.

3. The device according to claim 2, wherein the sensor is designed to detect heat radiation and receives infrared radiation through a window in a housing of the alert device, with the transceiver, or transmitter and receiver, forming the communication interface being disposed behind the window.

4. The device according to claim 3, further comprising a sabotage detector having comprising an infrared transmitter and an infrared receiver, and wherein the infrared transmitter or the infrared receiver is formed by an IrDA transceiver, or IrDA transmitter and IrDA receiver, which forms the communication interface.

5. A danger alert system comprising at least one danger alert device, said device comprising a sensor for sensing a danger parameter, evaluation electronics for evaluating sensor signals, a memory for storing alarm data, a communication interface, and further comprising a portable operator control module for wireless communication with at least one danger alert device, said system comprising forming the operator control module by a remote control, or a computer which comprises an analog communication interface, and wherein the two communication interfaces are designed for communication in a radio-frequency or infrared range.

6. A system according to claim 5, further comprising forming each of the communication interfaces by a transceiver or a transmitter and receiver, and effecting the communication between a danger alert device and an operator control module in accordance with the IrDA or the Bluetooth standard.

7. A system according to claim 5, further comprising setting the danger alert device to a data transmission mode through the operator control module.

8. A system according to claim 7, further comprising setting the danger alert device automatically to the data transmission mode when the operator control module is authenticated.

9. A system according to claim 8, further comprising using a code or a cryptological procedure to effect authentication.

10. A system according to claim 7, further comprising transmitting data stored in the danger alert device during the transmission mode to the operator control module.

11. A system according to claims 0.7, 8 and 9, further comprising effecting a parameterization and/or software update of the danger alert device in the data transmission mode.

12. A system according to claim 7, further comprising upon exchange of safety-related data in the transmission mode, dispatching a sabotage message via the danger alert device.

13. The device according to claim 2, wherein the radio frequency range is in accordance with a Bluetooth standard.

14. The device according to claim 2, wherein the infrared range is in accordance with an IrDA standard.

15. The system according to claim 7, wherein the data stored is alarm-related data and/or location images.
